(19) United States
(12) Patent Application Publication
(10) Pub. No.: US 2023/0155231 A1
(43) Pub. Date: May 18, 2023

(54) BATTERY MODULE AND BATTERY PACK INCLUDING THE SAME

(71) Applicant: LG Energy Solution, LTD., Seoul (KR)

(72) Inventors: Soo Youl Kim, Daejeon (KR); Youngho Lee, Daejeon (KR); Junkyu Park, Daejeon (KR); Han Ki Yoon, Daejeon (KR); Jeonghyeon In, Daejeon (KR)

(21) Appl. No.: 17/798,022

(22) PCT Filed: Jul. 13, 2021
(86) PCT No.: PCT/KR2021/008943

§ 371 Date: Aug. 5, 2022

(30) Foreign Application Priority Data
Aug. 14, 2020 (KR) 10-2020-0102382

(51) Int. Cl. H01M 50/24; H01M 50/211; H01M 50/264; H01M 50/691

(52) U.S. Cl. CPC H01M 50/24; H01M 50/211; H01M 50/264; H01M 50/691

(57) ABSTRACT

A battery module including: a battery cell stack including a plurality of battery cells; a housing for accommodating the battery cell stack; a pair of busbar frames at a front end and a back end of the battery cell stack; a connecting portion that connects the pair of busbar frames, and is formed of a flexible flat cable (FFC); a connector formed on each of the busbar frames and coupled to the connecting portion; and a film portion formed between the connector and an upper portion of the housing.

### CROSS-REFERENCE TO RELATED APPLICATIONS

This application is a US national phase of international Application No. PCT/KR2021/008943 filed on Jul. 13, 2021, and claims the benefit of Korean Patent Application No. 10-2020-0102382 filed on Aug. 14, 2020 with the Korean Intellectual Property Office, the disclosures of which are incorporated herein by reference in their entirety.

### TECHNICAL FIELD

The present disclosure relates to a battery module and a battery pack including the same, and more particularly, to a battery module including a structure for preventing penetration of moisture, and a battery pack including the same.

### BACKGROUND ART

A secondary battery has attracted much attention as an energy source in various products such as a mobile device and an electric vehicle. The secondary battery is a potent energy resource that can replace the use of existing products that consume fossil fuels, and is in the spotlight as an environment-friendly energy source because it does not generate by-products due to energy use.

Recently, along with a continuous rise in demand for a large-capacity secondary battery structure, including the utilization of the secondary battery as an energy storage source, there is a growing demand for a battery pack of a multi-module structure which is an assembly of battery modules in which a plurality of secondary batteries are connected in series/parallel.

Meanwhile, when a plurality of battery cells are connected in series/parallel to form a battery pack, a common method of manufacturing a battery pack includes manufacturing a battery module composed of at least one battery cell and then adding other components to the at least one battery module.

Such a battery module may include a battery cell stack in which a plurality of battery cells are stacked, a housing for accommodating the battery cell stack, and a busbar frame for covering the front and rear surfaces of the battery cell stack and equipped with a busbar.

FIG. 1 is illustrates a moisture inflow route of a conventional battery module.

As illustrated in FIG. 1, a conventional battery module includes a battery cell stack 10 in which a plurality of battery cells are stacked, a housing for covering the battery cell stack 10, a busbar frame 30 for covering the front and rear surfaces of the battery cell stack 10, an insulating cover 70 for covering the outer side surface of the busbar frame 30, and an end plate 80 for covering the outer side surface of the insulating cover.

A connector 50 coupled with a flexible flat cable (FFC) 40 can be formed on the outer side portion of the busbar frame 30. More specifically, a busbar frame 30 is formed on the front and rear surfaces of the battery cell stack 10, respectively, a connector 50 is formed on the outer side surface of each busbar frame 30, and the FFC 40 is formed in the upper side space of the battery cell stack 10, so that the connectors 50 formed on the two busbar frames 30 can be connected with each other.

During the assembly process of the FFC, a robot arm equipment can be used to automate the battery module assembly line. Here, the robot arm grasps the FFC and assembles it in a vertical direction toward the upper surface portion of the battery cell stack. The FFC, which has moved downward in the vertical direction, can be combined with the connector located at both ends of the battery cell stack. An upper portion of the connector coupled with the FFC moving vertically downward may have an open form.

When the inside of the battery module is placed in a high temperature and high humidity environment, condensed moisture may be formed on the lower side surface of the upper portion 21 of the housing, and moisture moving along the lower side surface of the upper portion 21 may flow into the inside of the connector 50 through the FFC or may directly flow into the inside of the connector 50.

When moisture flows into the inside of the connector, a short circuit may occur at the connection part between the connector 50 and the FFC 40, damaging the sensing function of the connector and the FFC, and causing an ignition phenomenon inside the battery module.

### SUMMARY

It is an objective of the present disclosure to provide a battery module including a structure that allows the moisture inside the battery module to be safely discharged to the outside.

The objective of the present disclosure is not limited to the aforementioned objective, and other objectives which are not described herein should be clearly understood by those skilled in the art from the following detailed description.

In order to achieve the above objective, according to one exemplary embodiment of the present disclosure, there is provided a battery module comprising: a battery cell stack in which a plurality of battery cells are stacked; a housing for accommodating the battery cell stack; busbar frames formed at both ends of the battery cell stack; a connecting portion that connects the busbar frames arranged at both ends, and is formed of a flexible flat cable (FFC); and a connector formed on the busbar frame and coupled to the connecting portion, wherein a film portion is formed between the connector and the upper side portion of the housing.

The battery further includes an insulating cover for covering the outside of the busbar frame; and an end plate for covering the outside of the insulating cover, wherein the film portion may guide the moisture that flows inside to a passage formed between the end plate and the insulating cover.

The insulating cover may include an extension portion formed on the lower side of the film portion.

The extension portion may be formed to be inclined downward in a direction in which the end plate is located.

The tip end of the extension portion may be formed to be curved upward.

A crack between the upper portion of the housing and the end plate may be connected with the extension portion.

The passage may be connected with the outside of the housing, and moisture guided to the passage may be discharged to the outside of the housing through the passage.

The film portion may be formed in a size corresponding to the upper portion of the housing.

The film portion may be coupled with both edge portions of the upper portion of the housing by an adhesive member, respectively, and a moisture moving passage may be formed in the space formed between the adhesive members.

The film portion may be formed of a polycarbonate sheet.

According to another exemplary embodiment of the present disclosure, there is provided a battery pack comprising the above-mentioned battery module.

A battery module and a battery pack including the same according to one exemplary embodiment of the present disclosure can discharge moisture formed on the lower surface of the upper side portion to the outside through a moisture barrier film between the connector and the upper portion of the housing.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is an illustration of a moisture inflow route of a conventional battery module;

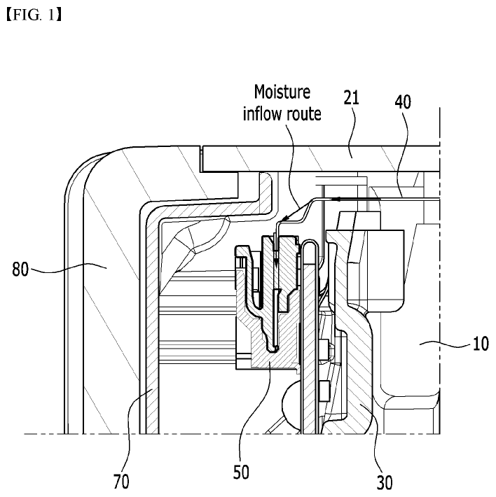

FIG. 2 is an exploded perspective view of a battery module according to one exemplary embodiment of the present disclosure;

FIG. 3 is an illustrated of the battery module of FIG. 2 after it has been assembled;

FIG. 4 is a cross-sectional view along a section A-A′ of FIG. 3; and

FIG. 5 is a partial view showing the direction in which moisture moves through the moisture barrier film.

### DETAILED DESCRIPTION

It should be appreciated that the exemplary embodiments, which will be described below, are illustrative to assist in the understand the present disclosure, and the present disclosure can be variously modified to be carried out differently from the exemplary embodiments described herein. However, in the description of the present disclosure, the specific descriptions and illustrations of publicly known functions or constituent elements will be omitted when it is determined that the specific descriptions and illustrations may unnecessarily obscure the subject matter of the present disclosure. In addition, in order to help understand the present disclosure, the accompanying drawings are not illustrated based on actual scales, but parts of the constituent elements may be exaggerated in size.

As used herein, terms such as first, second, and the like may be used to describe various components, and the components are not limited by the terms. The terms are used only to discriminate one component from another component.

Further, the terms used herein are used only to describe specific exemplary embodiments, and are not intended to limit the scope of the present disclosure. A singular expression includes a plural expression unless they have definitely opposite meanings in the context. It should be understood that the terms “comprise”, “include”, and “have” as used herein are intended to designate the presence of stated features, numbers, steps, movements, constitutional elements, parts or combinations thereof, but it should be understood that they do not preclude a possibility of existence or addition of one or more other features, numbers, steps, movements, constitutional elements, parts or combinations thereof.

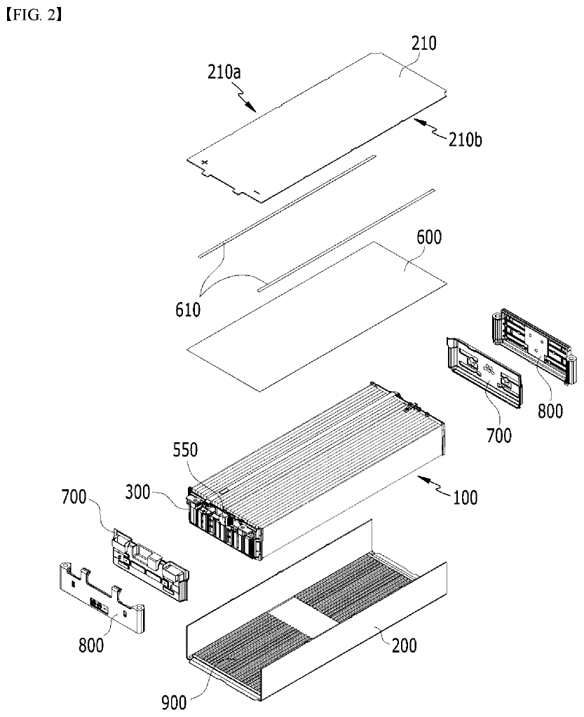

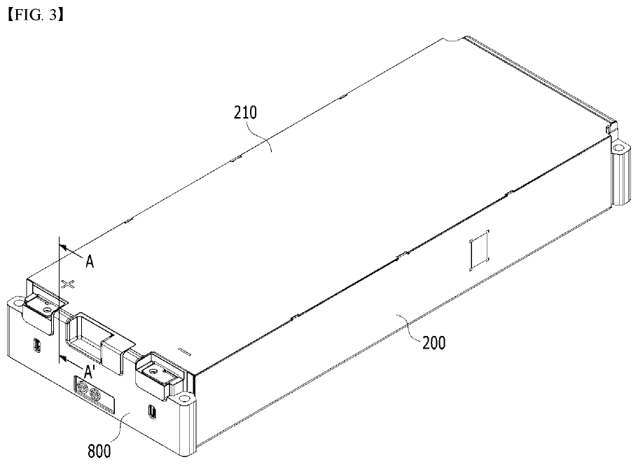

A battery module according to one exemplary embodiment of the present disclosure will be described with reference to FIGS. 2 and 3.

FIG. 2 is an exploded perspective view of a battery module according to one exemplary embodiment of the present disclosure. FIG. 3 is an illustration of the battery module of FIG. 2 after it has been assembled.

As illustrated in FIGS. 2 and 3, the battery module according to one exemplary embodiment of the present disclosure includes a battery cell stack 100 in which a plurality of battery cells are stacked, a housing 200 for accommodating the battery cell stack 100; and a busbar frame 300 formed at both ends of the battery cell stack 100. The battery module also includes a connecting portion 400 that connects the busbar frames 300 arranged at both ends, respectively, and is formed of a flexible flat cable (FFC), and a connector 500 formed on the busbar frame 300 and coupled with the connecting portion 400. A film portion 600 is formed between the connector 500 and the upper portion 210 of the housing 200.

The battery cell is a secondary battery and can be configured into a pouch-type secondary battery. Such a battery cell may include a plurality of cells, and the plurality of battery cells may be stacked together to be electrically connected with each other, thereby forming the battery cell stack 100. Each of the plurality of battery cells may include an electrode assembly, a cell case, and an electrode lead protruding from the electrode assembly.

The housing 200 accommodates the battery cell stack 100. The housing 200 can be formed of a U-shaped frame 200 and an upper portion 210 as shown in FIG. 2. The U-shaped frame 200 may include a bottom portion and both side portions. Although not illustrated in FIG. 2, the housing 200 can be formed of upper, lower, left and right portions to cover the upper, lower, left and right surfaces, respectively, of the battery cell stack 100. The battery cell stack 100 accommodated inside the housing 200 can be physically protected through the housing 200.

The busbar frame 300 is formed to cover the front and rear surfaces of the battery cell stack 100, is located on the front and rear surfaces of the battery cell stack 100, and can be connected with electrode leads that extend from the plurality of battery cells. In more detail, electrode leads extending through the busbar frame 300 are coupled to the plurality of busbars mounted on the busbar frame 300, to electrically connect the battery cells and the busbar.

End plate 800 is formed on the outside of the busbar frame 300 of the battery cell stack 100, so that it can cover the battery cell stack 100 and the busbar frame 300.

The end plate 800 can protect the busbar frame 300, the battery cell stack 100, and various electrical equipment connected thereto from external impacts, and at the same time, guide the electrical connection between the battery cell stack 100 and an external power. An insulating cover 700 can be inserted between the end plate 800 and the busbar frame 300. The insulating cover 700 may cut off the electrical connection between the busbar frame 300 and the outside to ensure the insulation performance of the battery module.

A thermal conductive resin layer 900 can be formed on the bottom surface 200 of the housing bottom. The battery cell stack 100 is located on the upper side of the thermal conductive resin layer 900, and heat generated from the battery cell stack 100 can be transferred to the outside of the battery module. According to this exemplary embodiment, the thermal conductive resin layer 900 may be formed of a thermal resin.

According to the embodiment of the present disclosure, the battery module includes a connecting portion 400 that connects the busbar frames 300 arranged at both ends, respectively, and is formed of a flexible flat cable (FFC). The connecting portion 400 may be parallel to the longitudinal direction of any one of the plurality of battery cells constituting the battery cell stack 100.

Since the connecting portion 400 can be formed of a soft cable to be curved, the circuit for electrical connection between the busbar frames is inserted in the inside of the cable, thereby making it easy to cope with external impacts.

The connector 500 is formed on the busbar frame 300 and coupled with the connecting portion 400. The connector 500 can sense information such as voltage and temperature of a plurality of battery cells constituting the battery cell stack 100. The connecting portion 400 may transmit information sensed from the rear surface of the battery cell stack 100 to the connector 500 located on the front surface of the battery cell stack 100.

According to the embodiment of the present disclosure, a film portion 600 is formed between the connector 500 and the upper portion 210 of the housing 200. The film portion 600 may guide moisture formed on the lower surface of the upper portion 210 of the housing 200 to a passage formed between the insulating cover 700 and the end plate 800. The film portion 600 may include a polycarbonate sheet.

Conventionally, moisture formed on the lower side of the upper portion of the housing flows into a connector having an open upper side, and may cause a short circuit inside the connector. Therefore, according to the embodiment of the present disclosure, the film portion 600 is installed between the connector 500 and the upper side portion 210 of the housing 200, and moisture formed on the lower side of the upper portion 210 moves along the upper surface of the film portion 600, without falling on the portion where the connector 500 is located, and immediately passes through the upper surface of the insulating cover 700, through the passage P between the insulating cover 700 and the end plate 800, and falls to the outside of the battery module.

When the battery module to which the FFC vertical assembly is applied through this moisture discharge structure is placed in environmental conditions with high temperature and high humidity, it is possible to prevent the inflow of moisture into the connector 500 and thus, protect the sensing function of the battery module.

A battery module in which a film portion is formed in accordance with one exemplary embodiment of the present disclosure will be described with reference to FIGS. 2, 4 and 5.

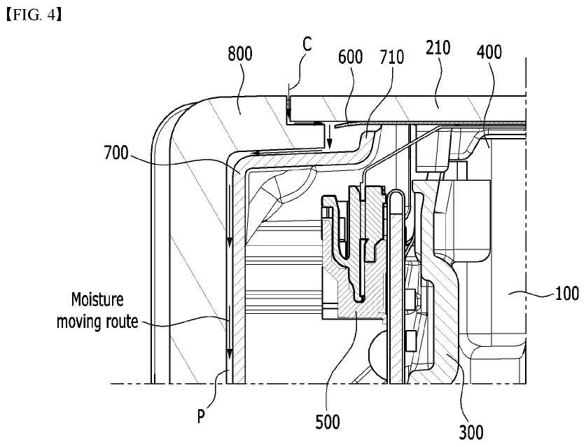

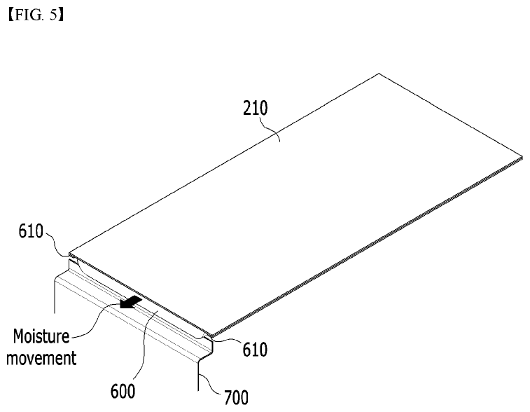

FIG. 4 is a cross-sectional view of a section A-A′ of FIG. 3. FIG. 5 is a partial view showing the direction in which moisture moves through the moisture barrier film.

According to the embodiment of the present disclosure, the insulating cover 700 may include an extension portion 710 that protrudes from the lower side of the film portion 600. Therefore, moisture flowing along the upper surface of the film portion 600 may fall to the upper surface of the insulating cover 700 without falling to the portion where the connector 500 is located. The extension portion 710 may be formed to be inclined in a direction in which the end plate 800 is located. The tip end of the extension portion 710 is formed to be curved upward, and the upper surface of the extension portion 710 may be formed in an inclined manner. Therefore, it is possible to prevent moisture from falling on the upper surface of the insulating cover 700 from flowing in a reverse direction toward the tip end of the extension portion 710 and falling on the connector 500.

Moisture that has fallen on the upper side of the insulating cover 700 can move in the direction in which the end plate 800 is located along the inclined upper surface of the insulating cover 700. A passage P may be formed between the end plate 800 and the insulating cover 700. Moisture guided in the direction in which the end plate 800 is located can be discharged to the outside of the housing 200 through the passage P formed between the end plate 800 and the insulating cover 700.

Further, according to the embodiment of the present disclosure, a crack C may be formed between the upper side portion 210 of the housing 200 and the end plate 800. The crack C may be connected with the upper surface of the insulating cover 700 and the upper surface of the extension portion 710. In some cases, moisture may flow in from the outside of the battery module. In such a case, moisture may flow into the crack C between the end plate 800 and the housing 200 at the upper side of the battery module. Even in this case, the moisture flowing into the device is guided to the upper surface of the insulating cover 700, and the moisture thus guided may be discharged to the outside of the housing 200 through the passage P formed between the end plate 800 and the insulating cover 700.

The film portion 600 may have a size corresponding to the upper portion 210 of the housing. In this case, both edge portions 210a and 210b of the upper portion 210 of the housing and the film portion 600 may be coupled to each other by an adhesive member 610. Further, as illustrated in FIG. 5, a moisture moving passage may be formed in a space formed between the adhesive members 610. According to this embodiment, the adhesive member 610 may be formed of a double-sided tape.

The film portion 600 formed of a thin film is attached to the edge portions on a lower surface of the upper portion 210 of the housing through an adhesive member 610 formed of a double-sided tape, thereby minimizing a space occupancy in the battery module due to the film portion 600 and the adhesive member 610.

The above-mentioned battery module can be included in a battery pack. The battery pack may have a structure in which one or more of the battery modules according to the embodiment of the present disclosure are gathered, and packed together with a battery management system (BMS) and a cooling device that controls and manages the battery's temperature, voltage, etc.

The battery pack can be applied to various devices. Such a device may be applied to a vehicle means such as an electric bicycle, an electric vehicle, or a hybrid vehicle, but the present disclosure is not limited thereto, and is applicable to various devices that can use a battery module, which also falls under the scope of the present disclosure.

Although the invention has been shown and described with reference to the preferred embodiments, the scope of the present disclosure is not limited thereto, and numerous other modifications and embodiments can be devised by those skilled in the art that will fall within the spirit and scope of the principles of the invention described in the appended claims. Further, these modified embodiments should not be understood individually from the technical spirit or perspective of the present disclosure.

1. A battery module comprising:
a battery cell stack comprising a plurality of battery cells;
a housing for the battery cell stack;
a pair of busbar frames formed at a front portion and a back portion of the battery cell stack;
a connecting portion that connects the pair of busbar frames and comprises a flexible flat cable (FFC);
a connector formed on each of the busbar frames and coupled to the connecting portion; and
a film portion formed between the connector and an upper portion of the housing.

2. The battery module of claim 1, further comprising
a pair of insulating covers for covering an outer surface of each of the pair busbar frames, respectively; and
a pair of end plates for covering an outer surface of each of the pair of insulating covers, respectively,
wherein the film portion guides moisture inside the batter module to a passage formed between each of the end plates and the insulating covers, respectively.

3. The battery module of claim 2, wherein:
each of the insulating covers comprises an extension portion that extends from the lower side of the film portion.

4. The battery module of claim 3, wherein:
the extension portion is inclined downward in a direction towards the respective end plate.

5. The battery module of claim 3, wherein:
a tip of the extension portion is curved upward.

6. The battery module of claim 3, wherein:
a crack between the upper portion of the housing and each of the end plates is connected with the respective extension portion.

7. The battery module of claim 2, wherein:
the passage is connected with the outside of the housing, and
wherein moisture in the passage is discharged to the outside of the housing through the passage.

8. The battery module of claim 1, wherein:
a size of the film portion corresponds to a size of the upper portion of the housing.

9. The battery module of claim 8, wherein:
the film portion is coupled with opposite edge portions of the upper portion of the housing by a plurality of adhesive members, and
a moisture moving passage is formed in the space between the plurality of adhesive members.

10. The battery module of claim 1, wherein:
the film portion is formed of a polycarbonate sheet.

11. A battery pack comprising the battery module of claim 1.
